(19) United States
(12) Patent Application Publication
(10) Pub. No.: US 2005/0228765 A1
(43) Pub. Date: Oct. 13, 2005

(54) Mechanism for synchronizing manafacturing information systems and document content management systems data

(75) Inventors: Chen-Chu Huang, Pingjhen City (TW); Ming-Rong Fu, Hsinchu City (TW); Chi-An Kao, Hsin-Chu City (TW); Yu-Chen Ting, Thubei City (TW); Pi-Chuan Lee, Dali City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co.

(21) Appl. No.: 10/759,669

(22) Filed: Jan. 16, 2004

(51) Int. Cl. G06F 7/00

(52) U.S. Cl. 707/1

(57) ABSTRACT

A method and apparatus to synchronize the heterogeneous databases of this invention, first extracts the files to be synchronized from a first database (in the case of the manufacturing facility, the online specification database). These files have a first format such as character or numeric data that is then converted to a second format such as the Engineering Data Workflow (EDW) or Lotus Notes to create the document object files of the second database. The converted files are then automatically attached to the second database for review by a document manager. The document manager is either a person responsible for reviewing changes to the second database or may be an automated reviewing mechanism. If the database modification is approved, the document manager generates a permission semaphore to gain access and use of the first database.

### BACKGROUND OF THE INVENTION

1. Field of the Invention

This invention relates generally to methods and apparatus that synchronize heterogeneous files within separate databases. More particularly, this invention relates to methods and apparatus that synchronize manufacturing specification data that has been retained within a manufacturing information system with the documentation data that is retained within a content management system.

2. Description of Related Art

Manufacturing enterprises are becoming more automated to improve the efficiency and quality of the fabrication of products. Products are designed using computer aided design systems. The processes and the recipes for each stage of the processes are created and described in databases such that the computer aided design systems create a workflow routing for the fabrication of the product within the manufacturing facility. The workflow routing calls for extraction of execution data from a manufacturing information system. The execution data describes the necessary equipment environment and operational settings for the equipment of a manufacturing facility. The design is further documented in a document database as a document object using formats commonly used for “engineering document workflow” (EDW) and Lotus Notes. The document database allows an archival process for auditing a design to insure the quality and reliability of the design and the efficiency of the processing in the manufacturing facility.

Refer now to FIG. 1 for more detail regarding the product information utilized in the fabrication of product and in the assurance of the quality of the product and its fabrication. The manufacturing information is controlled as real-time data used in advanced process control to provide the equipment environment and operational settings of equipment of a manufacturing facility. The content provides the coding for specification control and mis-operation prevention (MO). Generally, the data type is character and numeric coding that is used in programming the operation of the equipment of each workstation area of a manufacturing facility. Since the manufacturing equipment is used to fabricate different products that have a different processes with differing recipes for each stage of the processes, the programming development occurs within the manufacturing enterprise. Examples of the types of program systems containing the manufacturing information are the Recipe Management System (RMS), Preventive Maintenance System (PMS) to manage tool maintenance schedule, Equipment Constant System (ECS), Equipment Alarm Management System (ALM), and Advanced Process Control (APC).

The content management system controls the document database. The content management system (also referred to as a document management system) allows for an audit and review of a product design and the process workflow necessary to fabricate the process. The content provides the operation instructions (OI) for equipment employed in the fabrication of the product, the standard operation procedures (SOP) of the equipment, and the policies describing the rules involved in the design of the product. These documents include published specifications and procedures of the product and are retained as standard document objects provided by third party industrially accepted program providers such as EDW and Lotus Notes files.

The structure of a manufacturing facility of the prior art is shown schematically in FIG. 2. The manufacturing facility has a number of manufacturing workstations or process lines 5a, . . . , 5n. Each manufacturing workstation 5a, . . . ; 5n has differing types of manufacturing equipment 7a, 7b, . . . 7n and 9a, 9b, . . . , 9n configured for the fabrication of product. For example, the manufacturing facility would be an integrated circuit fabrication plant, where the manufacturing equipment 7a, 7b, . . . , 7n and 9a, 9b, . . . , 9n would be diffusion ovens, etching equipment, material deposition equipment that is used to form the integrated circuits upon a wafer. Each of the units of the manufacturing equipment 7a, 7b, . . . , 7n and 9a, 9b, . . . , 9n is controlled and monitored by a manufacturing execution system 10a, . . . , 10n. The manufacturing equipment 7a, 7b, . . . , 7n and 9a, 9b, . . . , 9n has actuators and sensors connected to the manufacturing execution system 10a, . . . , 10n to provide the necessary op rational setting to determine the necessary equipment environment and to provide the necessary feedback to determine that the manufacturing equipment 7a, 7b, . . . , 7n and 9a, 9b, . . . , 9n is functioning according to the designed parameters.

As the lots of product are dispatched for fabrication, the manufacturing execution system 10a, . . . , 10n extracts the necessary recipes or lists of process parameters that define how the manufacturing equipment 7a, 7b, . . . , 7n and 9a, 9b, . . . , 9n should process the raw materials (a wafer in the integrated circuit fabrication example) during a specific stage of the process of fabrication from the online specification database 25 through the manufacturing information system 20 via the network 15. The necessary recipes for each stage of a process are retained on the online specification database 25. A computer workstation 30 is in communication with the manufacturing information system 20 to allow a process engineer to modify any of the recipes and monitor any of the readings and alarms generated by sensors attached to the manufacturing equipment 7a, 7b, . . . , 7n and 9a, 9b, . . . , 9n and communicated through the manufacturing execution systems 10a, . . . , 10n to the manufacturing information system 20 for placement in the online specification database 25. The modifications to the processes are made through engineering change notices (ECN), with temporary or experimental changes referred to as temporary engineering change notices (TECN). The manufacturing information system 20 extracts the changes from the change notices (ECN/TECN) and alters the contents of the online specification database 25.

The design description and manufacturing specification documents for the product are controlled by the document management system 35 (also referred to as the content management system). The documentation is retained by the document status database 40. These documents describing the product design and manufacturing process provide a vehicle for auditing the process of the design and manufacture of the product to assure the quality, efficiency, and consistency. A computer workstation 45 is in communication with the document management system 35 to provide the original design documentation and to update this documentation as any changes in the product design and the manufacturing process are instituted.

Often a process engineer will institute modifications to recipes within the manufacturing information system 20. These changes may be either experimental (temporary) engineering change notices or permanent change notices. An order for fabrication of a lot of product maybe received, but the design as documented in the document status database 40 may not include modifications to the recipe. The product fabricated to the new recipe reflected by the change is now not consistent with that as ordered and may not function correctly or may not have suitable reliability. The inconsistency between the document status database 40 and the online specification database 25 is perpetuated because there is no way to synchronize the databases. There is essentially a “wall” 50 preventing communication 52 and 54 between the manufacturing information system 20 and the document management system 35. It becomes the responsibility of the engineer instituting the modifications to the recipes to make sure that if the online specification database 25 is modified, that the document objects of the document status database 40 reflect the changes.

U.S. Pat. No. 6,263,255 (Tan, et al.) describes an Advanced Process Control (APC) Framework that performs automatic process control operations through the design and development of a software framework that integrates factory, process, and equipment control systems. The APC Framework benefits semiconductor-manufacturing factories, or “fabs,” throughout the development of the APC Framework by using an iterative development approach. The APC Framework is designed to integrate seamlessly with commercially-available APC tools. The APC Framework specifies components and a component structure that enable multiple vendors to build and sell framework-compatible products using an open architecture that accommodates plug-and-play components. The APC Framework advantageously increases product yield distributions and equipment utilization, and lowers defect densities.

U.S. Pat. No. 6,038,540 (Krist, et al.) describes an adaptive process control and profit depiction system that is responsive to process measurement input signals, economic inputs, and physical environment inputs. The process control system features an interactive optimization modeling system for determining manipulated process variables (also known as set-points). These manipulated process variables are used to position mechanisms that control attributes of a manufacturing system, such as a valve controlling the temperature of a coolant or a valve controlling the flow rate in a steam line.

U.S. Pat. No. 5,777,876 (Beauchesne) describes a database system for a manufacturing factory environment that integrates a plurality of manufacturing processes used to control the manufacture of a number of electronic board products on a plurality of manufacturing lines. The database system responds to operator initiated commands and provides a predetermined number of control table structures in memory for storing predetermined types of control parameter entries used in controlling the manufacturing processes. The database system includes a number of control mechanisms, which in response to operator commands, performs sequences of operations that enable process steps to be added, applied or linked to other processes or modified in a reliable and efficient manner.

U.S. Pat. No. 5,321,605 (Chapman, et al.) illustrates a memory structure and related method for collecting and maintaining descriptive data with a multiplicity of interrelated process flows. A complex memory structure includes job entities, operation entities, and process entities. Operation entities are subordinate to job entities, and process entities are subordinate to operation entities. These entities are represented by tables that are linked together to indicate their position in the hierarchy and their sequencing within a process flow. The process entities describe specific activities accomplished to achieve organizational goals. Typically, resources are either consumed or released, or both, during a process. Bill-of-resource tables are subordinate to process entities and populated with data that identifies resources consumed by corresponding processes in the process flow. Attribute tables are subordinate to the resources listed in the bill-of-resources tables and populated with data that identifies attribute limitations, durations for which resources are used, and quantities of resources consumed. Branch and condition entities are positioned between operation entities or process entities to initiate alternate process flows to be taken when specified conditions are met. In addition, condition entities may specify conditions to be met before including particular bill-of-resource and attribute tables within a process flow.

U.S. Pat. No. 6,073,160 (Grantham, et al.) illustrates a method and apparatus for providing a general-purpose, multifunction, individually addressable, full-bandwidth bi-directional communication device with built-in Authentication, Authorization, and Accounting (AAA) capabilities that connects a home or business user with ATM and other switched broadband digital networks in a convenient, adaptable, extensible manner at reasonable cost. The device supports a Document Services Architecture (DSA) and, in particular, supports agent-based communications (including interaction with an Agent Instance Service) to ensure well-behaved communications and fair allocation of network resources among users. The device can be used in a heterogeneous environment and with different types of networks and protocols.

The online specification database 25 and the document status database 40 are essentially heterogeneous databases. The information for the manufacturing execution system 10a, . . . , 10n to set the equipment environment and operational settings of the manufacturing equipment 7a, 7b, . . . , 7n and 9a, 9b, . . . , 9n is generally formatted as character or textual data as shown in FIG. 1 and controlled by the manufacturing information system 20. The information of the documentation management system 35 are document objects formatted in the engineering data workflow or Lotus Notes formats.

Traditionally, most heterogeneous databases involve the use of dissimilar networks such as cellular telephone communications and computer communication networks where databases such as address and telephone books of a cellular telephone must be coordinated with the address and telephone books of a personal digital assistant or coordinated with an address and telephone book of a contact management program on a personal computer. The synchronization of databases within heterogeneous systems is well studied in the art.

U.S. Pat. No. 6,446,075 (Velasco) teaches a system and method for synchronizing a first database of a first class and a second database of a second class. A repository database is provided for storing metadata regarding the first database and the second database. The first database is automatically generated using a first portion of the metadata and the second database is automatically generated using a second portion of the metadata. A mapping between the first database and the second database is automatically generated using a third portion of the metadata stored in the repository database.

U.S. Pat. No. 6,195,662 (Ellis, et al.) describes a system and method for importing data from a source computer system, manipulating and transforming of that data, and exporting the data to a target computer system under control of a script processor using stored metadata definitions. Metadata is used to describe the properties of the data being manipulated. The metadata definitions are created to import data into the system, export data from the system, create views of the external data, store generic format data within the system, manipulates generic format data within the system and to control data flow through the system. Data is imported into the system using an import data definition to map the external data into an import data bag. Data imported into an import data bag becomes independent of the original data source. Data is manipulated within the system using script control commands and transformed within the system using rule sets that act upon data bags. Data is exported from the system using an export data definition to map the import data bag into the required export data bag format and then to write data in the export data bag to the external data target.

U.S. Pat. No. 5,970,490 (Morgenstern) teaches a method for processing heterogeneous data including high level specifications to drive program generation of information mediators, inclusion of structured file formats (also referred to as data interface languages) in a uniform manner with heterogeneous database schema, development of a uniform data description language across a wide range of data schemas and structured formats, and use of annotations to separate out from such specifications the heterogeneity and differences that heretofore have led to costly special purpose interfaces with emphasis on self-description of information mediators and other software modules.

### SUMMARY OF THE INVENTION

An object of this invention is to synchronize data retained in heterogeneous databases in order to control specification databases of a manufacturing information system and the documentation database of a document control system.

To accomplish at least this object, a method for synchronizing data begins by extracting the data from a first database of the heterogeneous databases retained on the first database retention device. An example of the first database would be the control specification database in the manufacturing information system. The extracted data is converted from a first format of the first database to format types of all remaining heterogeneous databases. In the example the remaining heterogeneous databases is the documentation database. Converting of the extracted data includes creating an identification of the data that includes a data identifier and a serial number

The converted data is then transferred to the document control database and attached to the remaining heterogeneous databases. In this example, the document database. A document manager reviews the attached converted data for synchronicity with existing data within the document database. The document manager (either a person or an automated review program) generates a permission semaphore. The permission semaphore from each of the remaining heterogeneous databases is transferred to the first database (the control specification database) to provide a status indicator indicating that the data is synchronized among the plurality of databases. The transferred permission semaphore to the first database grants authorization for usage of the first database.

### BRIEF DESCRIPTION OF THE DRAWINGS

FIG. 1 is a table describing the types and purpose for data retained within databases of a manufacturing facility of the prior art.

FIG. 2 illustrates schematically a manufacturing facility with heterogeneous databases employed within the manufacturing facility of the prior art.

FIG. 3 illustrates schematically a manufacturing facility with heterogeneous databases employed within the manufacturing facility having a synchronizing apparatus of this invention.

FIGS. 4a and 4b illustrates schematically an example of a manufacturing facility with heterogeneous databases employed within the manufacturing facility having a synchronizing apparatus of this invention.

FIGS. 5 and 6 are flowcharts showing the method for synchronizing heterogeneous databases of this invention.

### DETAILED DESCRIPTION OF THE INVENTION

To synchronize the heterogeneous databases of this invention, the files to be synchronized are first extracted from the first database (in the case of the manufacturing facility, the online specification database). These files have a first format such as character or numeric data formatting that is then convert d to a second format such as the Engineering Data Workflow (EDW) or Lotus Notes format to create the document object files of the second database. The converted files are then automatically attached to the second database for review by a document manager. The document manager is either a person responsible for reviewing changes to the second database or maybe an automated reviewing mechanism. Upon the review and if the database modification are approved, the document manager generates a permission semaphore to gain access and use of the first database. The permission semaphore is transferred to the first database to allow usage.

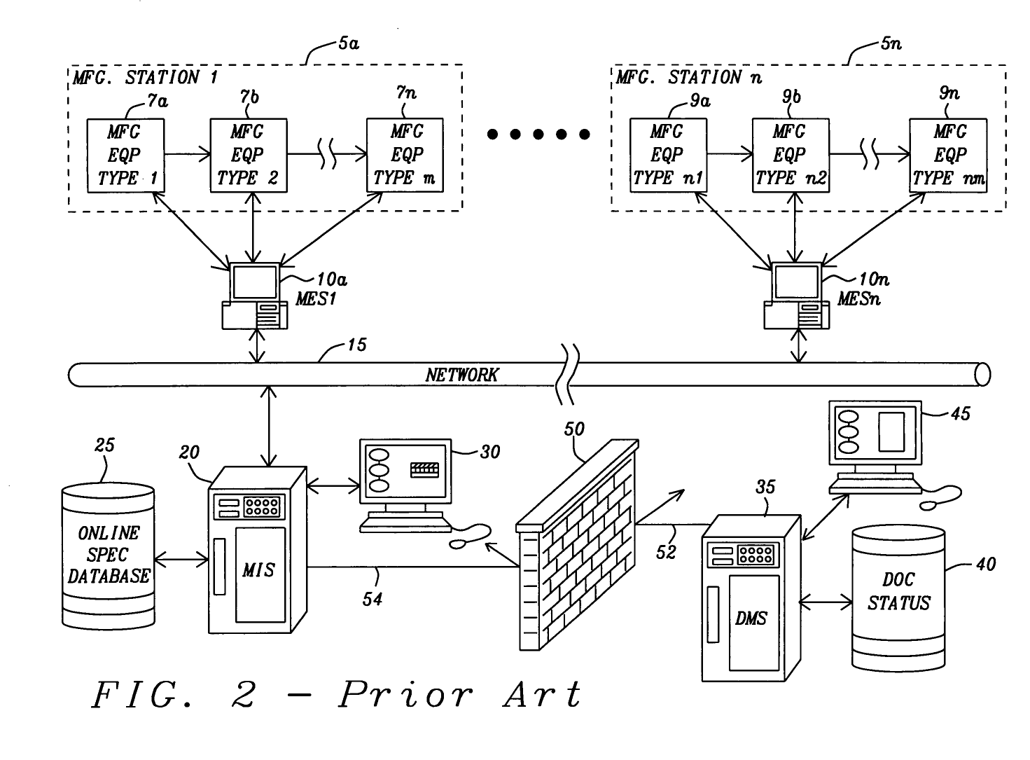

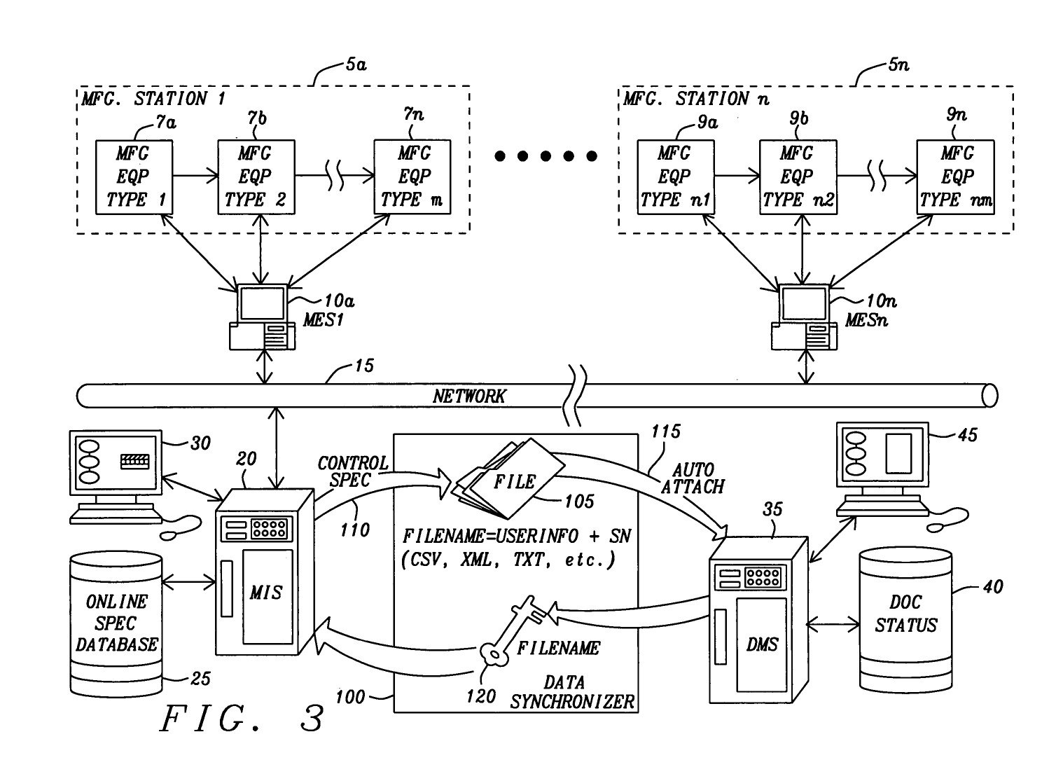

Refer now to FIG. 3 for a discussion of a manufacturing facility such as an integrated circuit fabrication complex having a data synchronizer of this invention. The manufacturing facility has manufacturing workstations 5a, . . . , 5n with various types of manufacturing equipment 7a, 7b, . . . , 7n and 9a, 9b, . . . , 9n as described in FIG. 2. The manufacturing equipment 7a, 7b, . . . , 7n and 9a, 9b, . . . , 9n is in communication with the manufacturing execution systems 10a, . . . , 10n to transfer the necessary commands for the actuators of the manufacturing equipment 7a, 7b, . . . , 7n and 9a, 9b, . . . , 9n and receive measurements of the environmental factors from the sensors placed within the manufacturing equipment 7a, 7b, . . . , 7n and 9a, 9b, . . . , 9n. The online specification database 25 provides a repository for the recipes for each stage of a process and for the responses from the sensors of the manufacturing equipment 7a, 7b, . . . , 7n and 9a, 9b, . . . , 9n. The manufacturing information system 20 communicates through the network 15 with the manufacturing execution systems 10a, . . . , 10n for the transference of the control codes and reception of the sensor data.

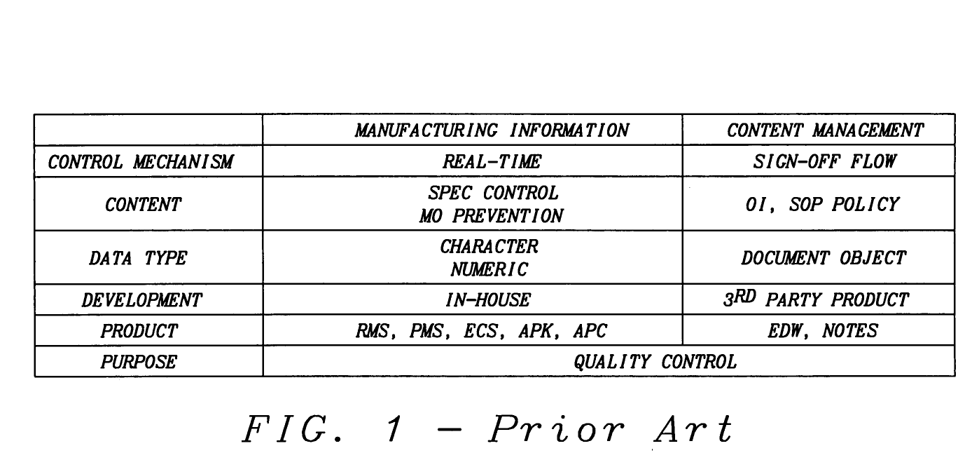

As described in FIG. 1, the computer workstation 30 is in communication with the manufacturing information system 20 to allow a process engineer to modify any of the recipes and monitor any of the readings and alarms generated by sensors attached to the manufacturing equipment 7a, 7b, . . . , 7n and 9a, 9b, . . . , 9n and communicated through the manufacturing execution systems 10a, . . . , 10n to the manufacturing information system 20 for placement in the online specification database 25.

Further as described in FIG. 1, the design description and manufacturing specification documents for the product are controlled by the document management system 35 and is retained by the document status database 40. The computer workstation 45 is in communication with the document management system 35 to provide the original design documentation and to update this documentation as any changes in the product design and the manufacturing process are instituted.

When a process engineer institutes modifications to recipes within the manufacturing information system 20, the inconsistency between the document status database 40 and the online specification database 25 is prevented from being perpetuated by synchronizing the databases with the data synchronizer 100. The data synchronizer 100 is in communication with the manufacturing information system 20 to extract 110 the controlling specification code files 105. The controlling specification code files 105 are then converted from the character or numeric data to the document object file type of the document management system 35. The data synchronizer 100 is further in communication with the document management system 35 such that the converted controlling specification code file 105 is the automatically attached 115 to the document status database 40.

A document manager then reviews the appended document object of the controlling specification for approval of the changes or modifications. As noted in FIG. 1, the document status database 40 is used as vehicle for auditing the quality of manufactured product and efficiency of the fabrication process for quality control. The approval of the modifications ensures consistency between the document objects of the document status database 40 and the online specification database 25.

The document manager maybe a responsible person evaluating documented controlling specification. Alternately, the document manager may be a rules based automation evaluation program that reviews the controlling specification to provide the necessary approval. Upon approval of the modification as documented in the attached 105 document object, a permission semaphore is generated by the document management system 35. The permission semaphore provides the production control rules that govern the implementation of the changes to the recipes of the stages of the process. The permission semaphore is transferred through the data synchronizer 100 to the manufacturing information system 20 to activate the usage of the modifications to the controlling specification.

The format of the converted controlling specification 105 aligns with the manufacturing enterprise standards or may be user-defined. It contains unique information that allows it to identify where it belongs. The filename should have some sort of user information identification and a serial number to provide a timing designation. For example, the Filename could be produced in format of “FAB CODE (fabrication facility identification coding)+TOOL ID (manufacturing equipment identification coding)+RECIPE NAME”. In this way, any auditing of the modifications may be traced to the initiator.

The data synchronizer 100 provides the following benefits:
1. There is no more need to enter operation rules or control parameters separately into the manufacturing information system 20 and document management system 35. The data synchronizer transfers the operation rules or control parameters of the manufacturing process to the enterprise document base.
2. High manufacturing quality or yield could be achieved because of all operation rules and constraints controlled by MIS are based on the manufacturing enterprise standard. This assures consistency.
3. Reduction of workload in auditing because all constraints, parameters, or rules, including the history log, are generated by the data synchronizer 100 easily. A relationship between yield analysis and parameter change history may be constructed, particularly for recipe changes.

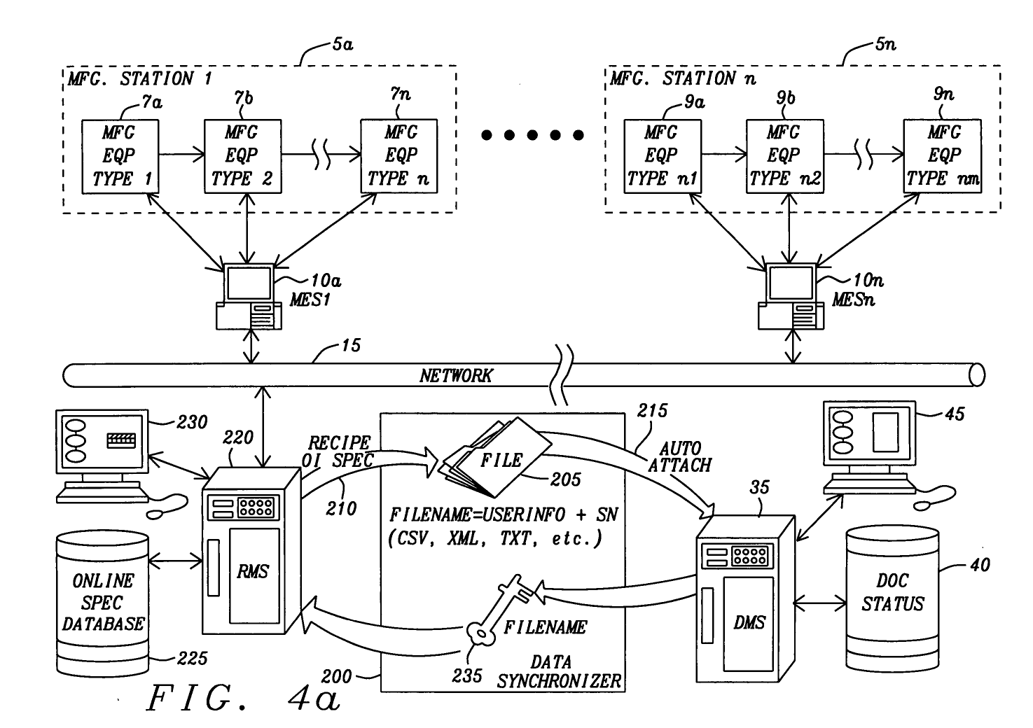

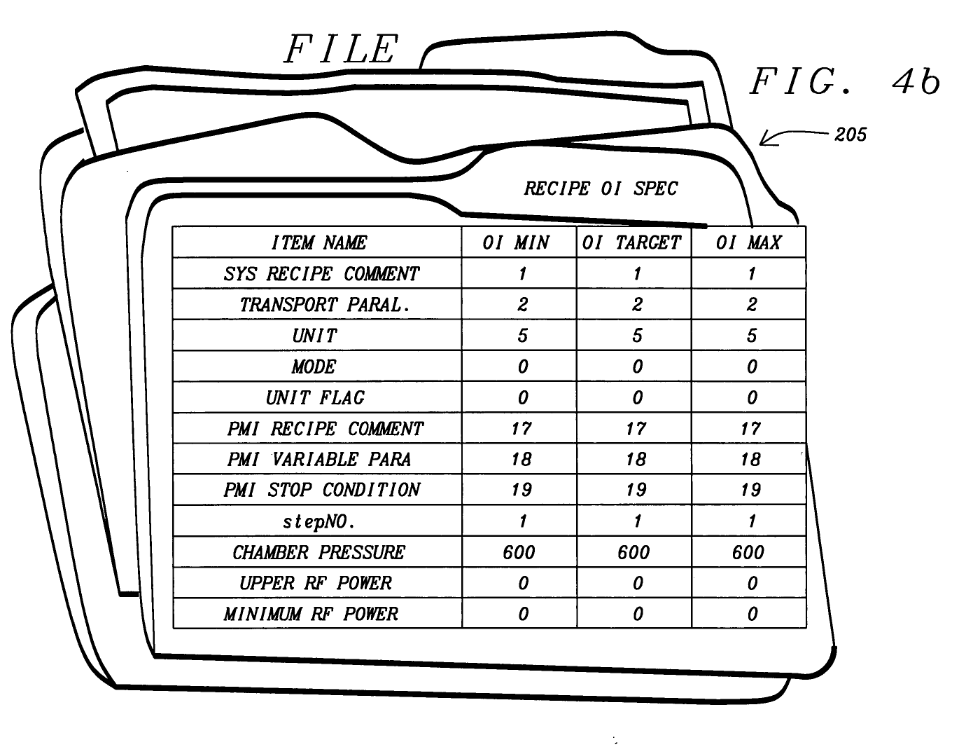

FIGS. 4a and 4b provide an illustration of the functioning of the data synchronizer 200. In this example, a manufacturing or process engineer modifies a recipe either through the computer workstation 230 or directly through the manufacturing equipment 7a, 7b, . . . , 7n and 9a, 9b, . . . , 9n controlled by the recipe management system 220, which has been provided as a subsystem of the manufacturing information system. The recipe management system 220 places the modifications in the online specification database 225. Upon completion of the updates to the online specification database 225, the data synchronizer 200 extracts 210 the modified recipe from the online specification database 225.

The extracted file 205 may have a table format such as shown in FIG. 4b where the parameters for the control manufacturing equipment 7a, 7b, . . . , 7n and 9a, 9b, . . . , 9n is detailed. Parameters for the “best known method” of executing a recipe in the process include the operational instructions (OI) such as an operational mode, chamber pressure, RF power, STOP conditions, etc., operating procedures, and policies necessary to fabricate the product. The extracted file 205 is converted to a document object format employed by the document management system 35. As described above, the Filename is formed with user information identification and a serial number to provide a timing designation.

The converted file 205 is then automatically attached 205 to the document status database 40 of the document management system 35. The converted file 205 is then reviewed and the contents used to edit other documents in the document status database 40. If the modifications of the converted file 205 are approved, a permission semaphore 235 is generated for transfer through the data synchronizer 200 to the recipe management system 220. The permission semaphore provides the control rules that permit activation of the modifications to the recipe of the manufacturing equipment 7a, 7b, . . . , 7n and 9a, 9b, . . . , 9n.

The data synchronizer may be a program process described in program code retained by a storage medium and executed by either the manufacturing information system (20 of FIG. 3 or 220 of FIG. 4a) or the document management system 35. Further the manufacturing information system (20 of FIG. 3 or 220 of FIG. 4a) and the document management system 35 must now be in communication with each other. This maybe accomplished by the network 15 or as separate communication network such as manufacturing enterprise's intranet or a global data communication network such as the Internet. The program process performs a method for synchronizing manufacturing data retained in a manufacturing specification database retention device and a documentation management system. As described above, these databases are heterogeneous in their data types are different and maybe included with other information not relevant to the other database.

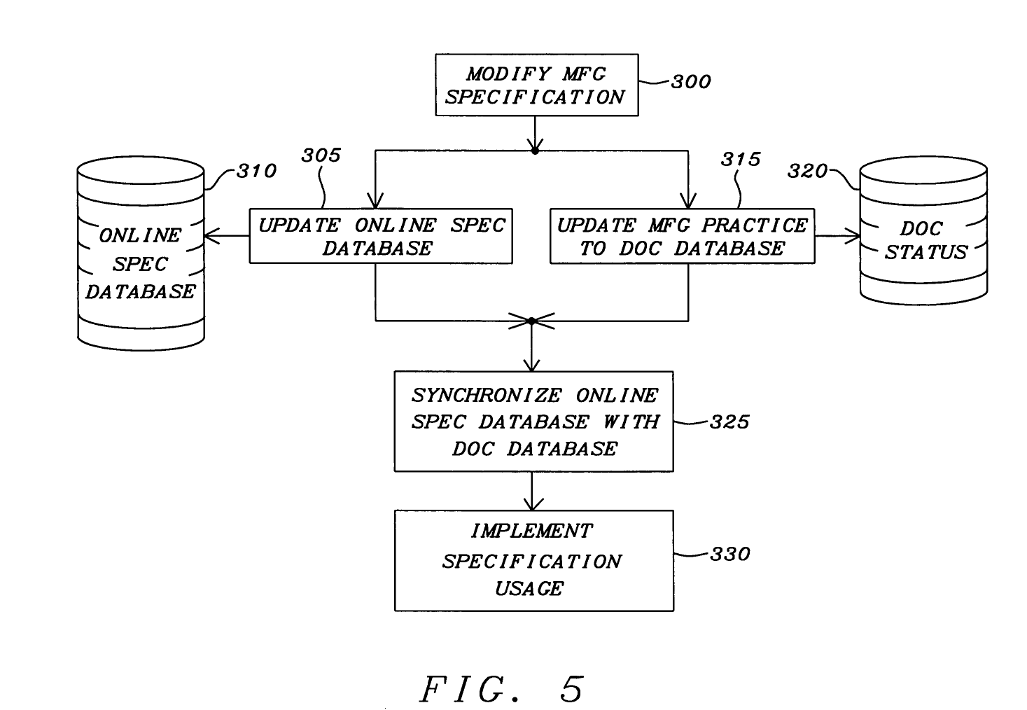

Refer now to FIG. 5 for a discussion of the method to synchronize manufacturing data retained in a manufacturing specification database retention device and a documentation management system that has been detailed in the program process. A manufacturing practice specification that details the parameters for the “best known method” to execute a recipe in the process that includes operational instructions (OI) such as operational mode, chamber pressure, RF power, STOP conditions, etc., operating procedures, and policies necessary fabricating product is modified (Box 300). The online specification database 310 is updated (Box 305) or the document status database 320 that provides a vehicle for auditing the manufacturing practices is updated (Box 315). Since these are generally serial updates that may have a delay upon completion of either of the updates the online specification database 310 and the document status database 320 are synchronized (Box 325). If the online specification database 310 is updated first, the file containing the modification of the parameters is extracted and converted to the file format of the document status database 320. A filename providing user information identification and a serial number to provide a timing designation is generated and the file is automatically attached to the document status database 320. The documents are reviewed and a permission semaphore containing the operational control rules for recipe of the manufacturing equipment being modified is generated. The permission semaphore is transferred to the manufacturing information system and the modifications to the specification are implemented.

While a reverse procedure is not explained in the preferred embodiment, it is within the concept of this invention that if the document status database is updated, a synchronization of the manufacturing information system could be similarly executed.

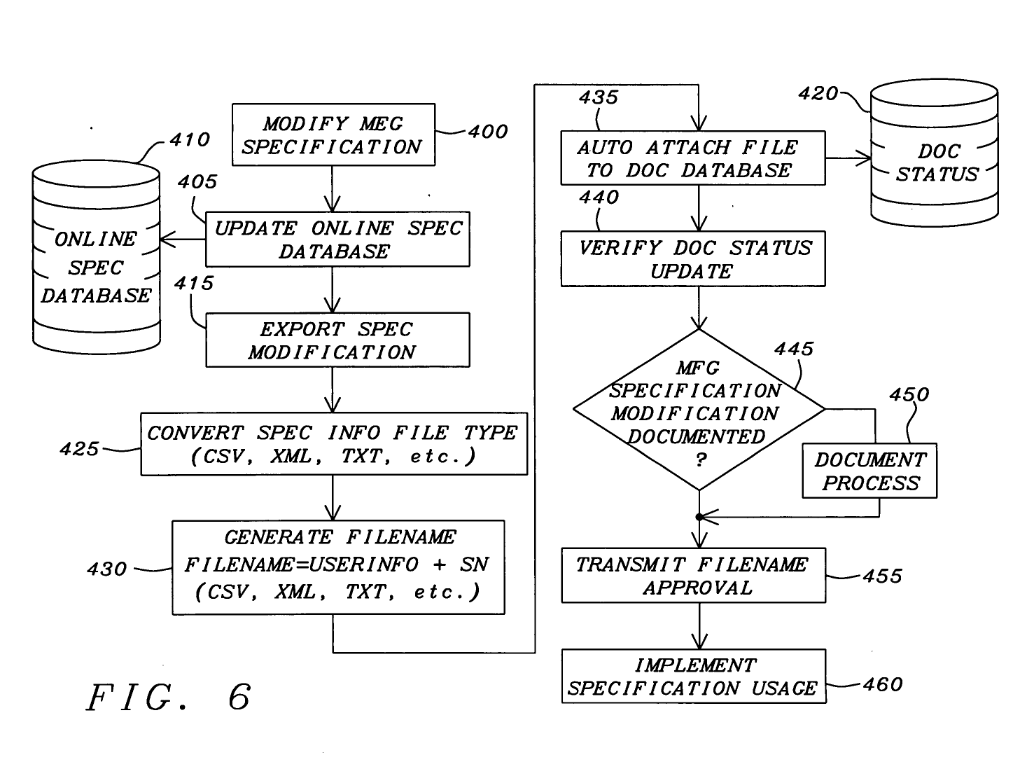

Refer now to FIG. 6 for a more detailed discussion of the method for synchronizing manufacturing data retained in a manufacturing specification database retention device and a documentation management system as executed by the program process. Manufacturing or process engineering creates (Box 400) a modification for the parameters of the “best known method” to execute a recipe in the process including the operational instructions (OI) such as operational mode, chamber pressure, RF power, STOP conditions, etc., operating procedures, and policies necessary fabricating product. The online specification database 410 of the manufacturing information system is updated (Box 405). The specification modification is extracted from the online specification database for exporting (Box 415). The modified specification is converted (Box 425) to a document object file type of the document status database 420. A filename is generated (Box 430) to include the user information identification and a serial number to provide a timing designation. The generated file is automatically attached (Box 435) to the document status database 420 and the status of the documentation is verified (Box 440). If the appropriate documents have not been updated (Box 445), the document is processed (Box 450) to reflect these updates. If the documents are updated (Box 450) or the documents are process for updating (Box 450), an approval semaphore is generated and transmitted (Box 455) to the manufacturing information system. Approval of the usage of the modification to the specification is granted and the modification of the specification is implemented (Box 460) for application to the manufacturing equipment.

While the preferred embodiment of this invention synchronizes the heterogeneous databases of a manufacturing information system and a document management system of a manufacturing enterprise, the data synchronizer and the method for synchronization of this invention are applicable to other types of heterogeneous databases employed in different computing systems with common information.

While this invention has been particularly shown and described with reference to the preferred embodiments thereof, it will be understood by those skilled in the art that various changes in form and details may be made without departing from the spirit and scope of the invention.

1. A data synchronization apparatus for synchronizing data retained in a plurality of heterogeneous databases comprising:
a data type conversion device in communication with a first database retention device to extract said data from a first database of said heterogeneous databases retained on said first database retention device, said extracted data being converted from a first format of said first database to format types of all remaining of the plurality of heterogeneous databases;
a data attachment device in communication with the data type conversion device to receive the data converted to the format types of the remaining plurality of databases and in communication with the plurality of heterogeneous databases to attach the data converted to the format types of the remaining plurality of databases; and
a release mechanism in communication with each of the remaining plurality of heterogeneous databases to receive a permission semaphore indicating that the data is synchronized among the plurality of databases and transfer the permission semaphore the first database to authorize usage of said database.

2. The data synchronization apparatus of claim 1 wherein the data type conversion device creates an identification of the data that includes a data identifier and a serial number.

3. The data synchronization apparatus of claim 1 wherein the release mechanism transfers a status indication for the remaining plurality of heterogeneous databases indicating the completion of the synchronization.

4. The data synchronization apparatus of claim 1 wherein a database manager of each of the remaining plurality of heterogeneous databases reviews the data converted to the format types of each of the remaining plurality of databases and generates one permission semaphore for each of the remaining plurality of heterogeneous databases.

5. The data synchronization apparatus of claim 1 wherein the first database is a manufacturing information system specification database retaining equipment environment and operational settings of equipment of a manufacturing facility.

6. The data synchronization apparatus of claim 5 wherein the specification database provides coding for controlling an operation of equipment of an integrated circuit fabrication facility.

7. The synchronization apparatus of claim 5 wherein the remaining plurality of heterogeneous databases are included in a content management system documenting the environment and the operational settings of the equipment of a manufacturing facility.

8. A manufacturing data synchronization apparatus for synchronizing manufacturing data retained in an manufacturing specification database of a manufacturing information system and a documentation database of a documentation management system, said manufacturing data synchronization apparatus comprising:
a data type conversion device in communication with a manufacturing specification database retention device to extract said manufacturing data from the manufacturing specification database, said extracted data being converted from a first format type of said manufacturing specification database to a second format of the documentation database;
a data attachment device in communication with the data type conversion device to receive the manufacturing data converted to the second format type and in communication with the documentation database to attach the manufacturing data converted to the second format type to said documentation database; and
a release mechanism in communication with documentation database to receive a permission semaphore indicating that the manufacturing data is synchronized between the manufacturing specification database of the manufacturing information system and the documentation database of the documentation management system to authorize usage of said manufacturing specification database.

9. The data synchronization apparatus of claim 8 wherein the data type conversion device creates an identification of the data that includes a data identifier and a serial number.

10. The data synchronization apparatus of claim 8 wherein the release mechanism transfers a status indication of the documentation database indicating the completion of the synchronization.

11. The data synchronization apparatus of claim 8 wherein a database manager of the documentation database reviews the manufacturing data converted to the second format type and generates the permission semaphore.

12. The data synchronization apparatus of claim 8 wherein the manufacturing information system specification database retains equipment environment and operational settings of equipment of a manufacturing facility.

13. The data synchronization apparatus of claim 12 wherein the specification database provides coding for controlling an operation of equipment of an integrated circuit fabrication facility.

14. The synchronization apparatus of claim 12 wherein the documentation database documents the environment and the operational settings of the equipment of a manufacturing facility.

15. A method for synchronizing data retained in a plurality of heterogeneous databases comprising the steps of:
extracting said data from a first database of said heterogeneous databases retained on said first database retention device;
converting said extracted data from a first format of said first database to format types of all remaining of the plurality of heterogeneous databases;
attaching the data converted to the format types of the remaining plurality of databases;
receiving a permission semaphore indicating that the data is synchronized among the plurality of databases; and
transferring the permission semaphore to the first database to authorize usage of said first database.

16. The method of claim 15 wherein converting said extracted data comprises the step of creating an identification of the data that includes a data identifier and a serial number.

17. The method of claim 15 wherein receiving a permission semaphore comprises the step of transferring a status indication for the remaining plurality of heterogeneous databases indicating the completion of the synchronization.

18. The method of claim 15 further comprising the steps of:
reviewing by a database manager the data converted to the format types of the remaining plurality of databases; and
generating one permission semaphore for each of the remaining plurality of heterogeneous databases.

19. The method of claim 15 wherein the first database is a manufacturing information system specification database retaining equipment environment and operational settings of equipment of a manufacturing facility.

20. The method of claim 19 wherein the manufacturing information specification database provides coding for controlling an operation of equipment of an integrated circuit fabrication facility.

21. The method of claim 19 wherein the remaining plurality of heterogeneous databases is included in a content management system documenting the environment and the operational settings of the equipment of a manufacturing facility.

22. An apparatus for synchronizing data retained in a plurality of heterogeneous databases comprising:
means for extracting said data from a first database of said heterogeneous databases retained on said first database retention device;
means for converting said extracted data from a first format of said first database to format types of all remaining of the plurality of heterogeneous databases;
means for attaching the data converted to the format types of the remaining plurality of databases;
means for receiving a permission semaphore indicating that the data is synchronized among the plurality of databases; and
means for transferring the permission semaphore to the first database to authorize usage of said first database.

23. The apparatus of claim 22 wherein said means for converting said extracted data comprises means for creating an identification of the data that includes a data identifier and a serial number.

24. The apparatus of claim 22 wherein means for receiving a permission semaphore comprises means for transferring a status indication for the remaining plurality of heterogeneous databases indicating the completion of the synchronization.

25. The apparatus of claim 22 further comprising:
means for reviewing by a database manager the data converted to the format types of the remaining plurality of databases; and
means for generating one permission semaphore for each of the remaining plurality of heterogeneous databases.

26. The apparatus of claim 22 wherein the first database is a manufacturing information system specification database retaining equipment environment and operational settings of equipment of a manufacturing facility.

27. The apparatus of claim 26 wherein the manufacturing information specification database provides coding for controlling an operation of equipment of an integrated circuit fabrication facility.

28. The apparatus of claim 26 wherein the remaining plurality of heterogeneous databases is included in a content management system documenting the environment and the operational settings of the equipment of a manufacturing facility.

29. A method for synchronizing manufacturing data retained in a manufacturing specification database retention device and a documentation management system comprising the steps of:
extracting said manufacturing data from the manufacturing specification database;
converting said extracted manufacturing data from a first format of said manufacturing specification database to a second format type of the documentation database;
attaching the manufacturing data converted to the second format type to the documentation database;
receiving a permission semaphore indicating that the manufacturing data is synchronized between the manufacturing specification database and the documentation database; and
transferring the permission semaphore to the manufacturing specification database to authorize usage of said manufacturing specification database.

30. The method of claim 29 wherein converting said extracted manufacturing data comprises the step of creating an identification of the manufacturing data that includes a manufacturing data identifier and a serial number.

31. The method of claim 29 wherein receiving a permission semaphore comprises the step of transferring a status indication of the documentation database indicating the completion of the synchronization.

32. The method of claim 29 further comprising the steps of:
reviewing by a database manager the manufacturing data converted to the second format type of the documentation database; and
generating the permission semaphore for the documentation database.

33. The method of claim 29 wherein the manufacturing specification database retention device is included in a manufacturing information system for retaining equipment environment and operational settings of equipment of a manufacturing facility.

34. The method of claim 33 wherein the manufacturing information specification database provides coding for controlling an operation of equipment of an integrated circuit fabrication facility.

35. The method of claim 33 wherein the documentation database is included in a content management system documenting the environment and the operational settings of the equipment of a manufacturing facility.

36. An apparatus for synchronizing manufacturing data retained in a manufacturing specification database retention device and a documentation management system comprising the steps of:
means for extracting said manufacturing data from the manufacturing specification database;
means for converting said extracted manufacturing data from a first format of said manufacturing specification database to a second format type of the documentation database;
means for attaching the manufacturing data converted to the second format type to the documentation database;
means for receiving a permission semaphore indicating that the manufacturing data is synchronized between the manufacturing specification database and the documentation database; and
means for transferring the permission semaphore to the manufacturing specification database to authorize usage of said manufacturing specification database.

37. The apparatus of claim 36 wherein means for converting said extracted manufacturing data comprises means for creating an identification of the manufacturing data that includes a manufacturing data identifier and a serial number.

38. The apparatus of claim 36 wherein receiving a permission semaphore comprises the step of transferring a status indication of the documentation database indicating the completion of the synchronization.

39. The apparatus of claim 36 further comprising the steps of:
means for reviewing by a database manager the manufacturing data converted to the second format type of the documentation database; and
means for generating the permission semaphore for the documentation database.

40. The apparatus of claim 36 wherein the manufacturing specification database retention device is included in a manufacturing information system for retaining equipment environment and operational settings of equipment of a manufacturing facility.

41. The apparatus of claim 40 wherein the manufacturing information specification database provides coding for controlling an operation of equipment of an integrated circuit fabrication facility.

42. The apparatus of claim 40 wherein the documentation database is included in a content management system documenting the environment and the operational settings of the equipment of a manufacturing facility.

43. A computer system in communication with a plurality of heterogeneous databases for synchronizing data retained in the plurality of heterogeneous databases, said computer system executing a program process comprising the steps of:
extracting said data from a first database of said heterogeneous databases retained on said first database retention device;
converting said extracted data from a first format of said first database to format types of all remaining of the plurality of heterogeneous databases;
attaching the data converted to the format types of the remaining plurality of databases;
receiving a permission semaphore indicating that the data is synchronized among the plurality of databases; and
transferring the permission semaphore to the first database to authorize usage of said first database.

44. The computer system of claim 43 wherein converting said extracted data comprises the step of creating an identification of the data that includes a data identifier and a serial number.

45. The computer system of claim 43 wherein receiving a permission semaphore comprises the step of transferring a status indication for the remaining plurality of heterogeneous databases indicating the completion of the synchronization.

46. The computer system of claim 43 wherein the program process further comprises the steps of:
reviewing by a database manager the data converted to the format types of the remaining plurality of databases; and
generating one permission semaphore for each of the remaining plurality of heterogeneous databases.

47. The computer system of claim 43 wherein the first database is a manufacturing information system specification database retaining equipment environment and operational settings of equipment of a manufacturing facility.

48. The computer system of claim 47 wherein the manufacturing information system specification database provides coding for controlling an operation of equipment of an integrated circuit fabrication facility.

49. The computer system of claim 47 wherein the remaining plurality of heterogeneous databases is included in a content management system documenting the environment and the operational settings of the equipment of a manufacturing facility.

50. A data retention medium having program code executable on a computer system in communication with a plurality of heterogeneous databases for synchronizing data retained in the plurality of heterogeneous databases, said program code, when executed by said program system, performs a program process comprising the steps of:
extracting said data from a first database of said heterogeneous databases retained on said first database retention device;
converting said extracted data from a first format of said first database to format types of all remaining of the plurality of heterogeneous databases;
attaching the data converted to the format types of the remaining plurality of databases;
receiving a permission semaphore indicating that the data is synchronized among the plurality of databases; and
transferring the permission semaphore to the first database to authorize usage of said first database.

51. The data retention medium of claim 50 wherein converting said extracted data comprises the step of creating an identification of the data that includes a data identifier and a serial number.

52. The data retention medium of claim 50 wherein receiving a permission semaphore comprises the step of transferring a status indication for the remaining plurality of heterogeneous databases indicating the completion of the synchronization.

53. The data retention medium of claim 50 wherein the program process further comprises the steps of:
reviewing by a database manager the data converted to the format types of the remaining plurality of databases; and
generating one permission semaphore for each of the remaining plurality of heterogeneous databases.

54. The data retention medium of claim 50 wherein the first database is a manufacturing information system specification database retaining equipment environment and operational settings of equipment of a manufacturing facility.

55. The data retention medium of claim 47 wherein the manufacturing information system specification database provides coding for controlling an operation of equipment of an integrated circuit fabrication facility.

56. The data retention medium of claim 47 wherein the remaining plurality of heterogeneous databases is included in a content management system documenting the environment and the operational settings of the equipment of a manufacturing facility.
